(19) United States
(12) Patent Application Publication
(10) Pub. No.: US 2026/0065383 A1
(43) Pub. Date: Mar. 5, 2026

(54) ANALYZING AND PRESENTING FACILITY RESOURCE USAGE DATA VIA A GUI

(71) Applicant: MASTERCARD INTERNATIONAL INCORPORATED, PURCHASE, NY (US)

(72) Inventors: Steven EARHART, Kirkwood, MO (US); Erik LUEDERS, Webster Groves, MO (US)

(21) Appl. No.: 18/822,063

(22) Filed: Aug. 30, 2024

(51) Int. Cl. G06Q 50/06; G06Q 10/063

(52) U.S. Cl. CPC G06Q 50/06; G06Q 10/063

(57) ABSTRACT

A computerized method analyzes and presents facility resource usage data. A facility feature query is received via a graphical user interface (GUI). A data category to be analyzed is determined using the facility feature query. Resource usage data of the determined data category is obtained from a facility resource usage data store. A plurality of facilities represented in the obtained resource usage data are identified and recorded in a response data structure. The plurality of facilities are recorded in an order according to a degree to which each facility satisfies a requirement of the facility feature query. Facility data of the plurality of facilities is presented from the response data structure in the order in which the plurality of facilities are arranged in the response data structure using the GUI, whereby facility data of a facility that best satisfies the requirement is prioritized in the GUI.

### BACKGROUND

It is desirable for companies and other entities to monitor energy resource usage, such as with respect to environmental, social, and governance (ESG) contexts. Further, in addition to monitoring, it is important but challenging for such companies to collect and effectively understand comprehensive facility information in the interest of making decisions based on those ESG contexts.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for analyzing and presenting facility resource usage data is described. A facility feature query is received via a graphical user interface (GUI). A data category to be analyzed is determined using the received facility feature query. Resource usage data of the determined data category is obtained from a facility resource usage data store using a query interface of the facility resource usage data store. A plurality of facilities represented in the obtained resource usage data are identified and the identified plurality of facilities are recorded in a response data structure. The plurality of facilities are recorded in an order according to a degree to which each facility of the plurality of facilities satisfies a requirement of the received facility feature query. Facility data of the plurality of facilities is presented from the response data structure in the order in which the plurality of facilities are arranged in the response data structure using the GUI, whereby facility data of a facility that best satisfies the requirement of the received facility feature query is prioritized in the GUI.

### BRIEF DESCRIPTION OF THE DRAWINGS

The present description will be better understood from the following detailed description read considering the accompanying drawings, wherein:

FIG. 1 is a block diagram illustrating an example system for analyzing facility resource usage data and responding to queries based on that analysis;

FIG. 2 is a sequence diagram illustrating an example process for analyzing and presenting facility data based on a received query;

FIG. 3 is a flowchart illustrating an example method for analyzing and presenting facility data based on a received query;

FIG. 4 is a flowchart illustrating an example method for updating presented facility data based on received updated resource usage data;

FIG. 5 is a diagram illustrating an example graphical user interface (GUI) for presenting facility data from a plurality of facilities;

FIG. 6 is a diagram illustrating an example GUI for presenting and updating facility data of a plurality of facilities; and

FIG. 7 illustrates an example computing apparatus as a functional block diagram.

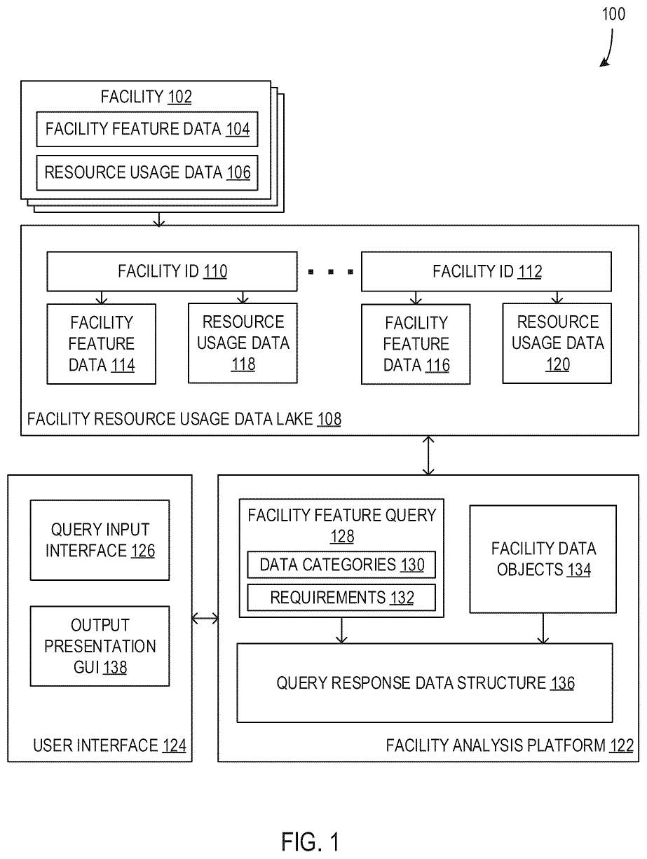

Corresponding reference characters indicate corresponding parts throughout the drawings. In FIGS. 1 to 7, the systems are illustrated as schematic drawings. The drawings may not be to scale. Any of the figures may be combined into a single example or embodiment.

### DETAILED DESCRIPTION

Aspects of the disclosure provide systems and methods for analyzing facility data and presenting results of that analysis via a graphical user interface (GUI) in response to facility feature queries. In some examples, the disclosure is directed to presenting carbon emissions data associated with a plurality of facilities for use in comparison and decision-making. A user is enabled to enter or otherwise provide a facility feature query. The disclosure determines one or more data categories and/or requirements from the facility feature query and uses those data categories and/or requirements to obtain resource usage data from a facility resource usage data store, such as a data lake. A plurality of facilities are identified as being represented in the obtained resource usage data. The data of those facilities is analyzed with respect to the facility feature query and, as a result of the analysis, the plurality of facilities are recorded to a memory in a response data structure in an order according to a degree to which each facility satisfies a requirement of the received facility feature query.

The disclosure operates in an unconventional manner at least by analyzing data from a large group of different facilities and enabling the results of the analysis to be viewed in a combined interface, enabling users to better understand features and patterns in the analyzed data. The disclosure provides a common platform for performing the described analysis and presentation, whereby processing, memory, and other resource costs are reduced when compared to less centralized systems. The disclosure describes GUIs that are tangible, relatable, and visually digestible to users, enabling those users to comprehend complex patterns more easily in large quantities of resource usage data and to make better decisions based thereon. For instance, in some examples, the disclosure, through the described data analysis and GUI presentation, provides a path toward “net zero” carbon emissions by complex entities through enabling improved decision making.

The disclosure includes enabling users to input queries into interfaces, analyzing data based thereon, and displaying dynamic response data via GUIs, such that the disclosure describes the integration of a process into a practical application. The disclosure describes automatically displaying resource usage data and dynamically moving elements of GUIs in response to updated resource usage data which provides a specific improvement over prior systems, resulting in an improved user interfaces and improved, more efficient resource use by the disclosed system.

FIG. 1 is a block diagram illustrating a system 100 for analyzing facility resource usage data 106 and responding to queries 128 based on that analysis. In some examples, the system 100 is configured to record facility feature data 104 and resource usage data 106 of facilities 102 in a facility resource usage data lake 108. The facility analysis platform 122 is configured to received facility feature queries 128 via a user interface 124, obtain facility data objects 134 from the facility resource usage data lake 108 based on the facility feature queries 128, and generate a query response data structure 136 using the obtained facility data objects 134. Query response data structures 136 are presented via an output presentation graphical user interface (GUI) 138 in response to the facility feature queries 128.

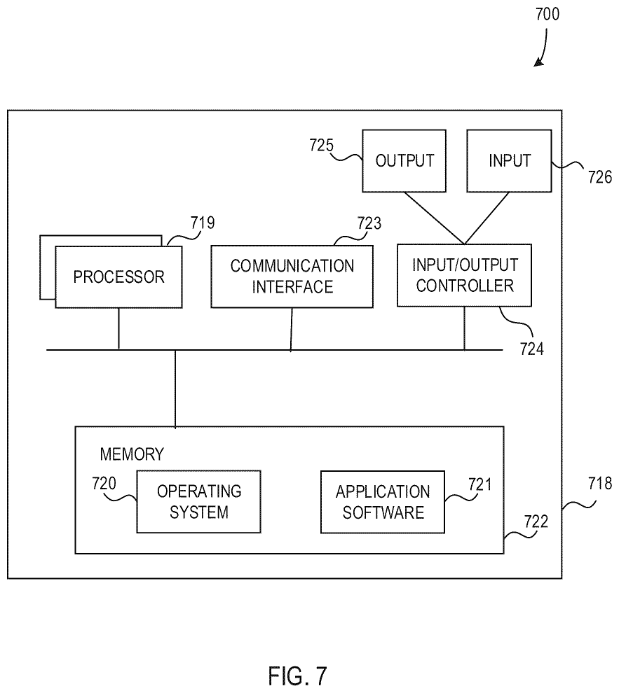

Further, in some examples, the system 100 includes one or more computing devices (e.g., the computing apparatus of FIG. 7) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the facility analysis platform 122 is executed on a first computing device and the facility resource usage data lake 108 is located on a second computing device within the system 100. The first computing device and second computing device are configured to communicate with each other via network connections. Alternatively, in some examples, other components of the facility analysis platform 122 (e.g., the user interface 124 of the facility analysis platform 122 and the analysis backend of the facility analysis platform 122) are executed on separate computing devices and those separate computing devices are configured to communicate with each other via network connections during the operation of the facility analysis platform 122. In other examples, other organizations of computing devices are used to implement system 100 without departing from the description.

Facilities 102 include buildings, installations, or the like that have equipment that consumes resources to operate. In some examples, the facilities 102 are server facilities that include computing devices that are used for data processing (e.g., a server farm that is used to perform machine learning processes, process large quantities of transactions, or the like). The facilities 102 collect or are otherwise associated with facility feature data 104 and/or resource usage data 106.

In some examples, the facility feature data 104 of a facility 102 includes location data associated with the facility 102. Such location data includes coordinates or other data identifying the geographic location of the facility 102, address data that identifies the location of the facility 102 with respect a city, state, territory, country, or the like, and/or other region-based indicators that are used during the analysis of the resource usage of the facility (e.g., data indicating the region of the facility 102 with respect to proximity to renewable energy sources). Further, in some examples, the facility feature data 104 includes technical feature data that describes the features of the equipment that is used at the facility 102, such as the quantity and type of computing devices being used at a server facility 102, the specifications of those computing devices, and/or descriptions of any other features of the facility 102 that affect the resource consumption of the facility 102 (e.g., temperature data or other weather data that affects the degree to which the facility 102 needs to be heated or cooled).

Additionally, in some examples, the resource usage data 106 of a facility 102 includes data that is indicative of the use of electricity and/or other resources over time by the facility 102. For instance, in an example, the resource usage data 106 includes data indicating the quantity of electricity consumed by all the equipment in the facility 102 during each minute, hour, and/or day of operation by the facility 102. Further, in some examples, the resource usage data 106 includes data indicative of the quantity of electricity consumed by specific devices within the facility 102, such that device-level energy use data can be analyzed as described herein. Alternatively, or additionally, the resource usage data 106 includes data indicative of the consumption of water, fuel, or other resources by the facility 102 and/or specific equipment within the facility 102 without departing from the description.

Further, in some examples, a facility 102 is a large building with many computing devices and data storage devices. In other examples, a facility 102 is a single room or area with one or just a few computing devices. It should be understood that, in other examples, facilities 102 include a variety of different types of buildings, rooms, areas, or locations with a wide range of different resource-consuming equipment without departing from the description.

The facility resource usage data lake 108 is configured to store data that is received or otherwise obtained from the facilities 102. In some examples, the facility resource usage data lake 108 stores the data from facilities 102 in association with facility IDs 110-112 of those facilities 102. As illustrated, a facility ID 110 of a facility 102 is associated with the facility feature data 114 and resource usage data 118, while a facility ID 112 of another facility 102 is associated with facility feature data 116 and resource usage data 120. Thus, during analysis, the data from a first facility 102 can be compared or otherwise analyzed against the data from a second facility 102. It should be understood that, in other examples, the data in the facility resource usage data lake 108 is stored in other configurations and/or formats without departing from the description. Additionally, or alternatively, in other examples, the data from the facilities 102 is stored in other types of data stores, such as databases or the like, without departing from the description.

In some examples, the facilities 102 provide data to the facility resource usage data lake 108 via one or more interfaces. For instance, in an example, the facility resource usage data lake 108 exposes an interface that facilities 102 use to send the facility feature data 104 and the resource usage data 106 to the data lake 108. Alternatively, or additionally, the facility resource usage data lake 108 is configured to send requests for data to the facilities 102 and enable the facilities 102 to respond to those requests with the requested data. Such requests may be sent periodically or based on the occurrence of specific events.

The facility analysis platform 122 includes hardware, firmware, and/or software configured to receive facility feature queries 128, obtain data for facility data objects 134 from the facility resource usage data lake 108, to generate response data in response to the received facility feature queries 128, and to populate the query response data structure 136 with that generated response data. The query response data structure 136 is then provided in response to the facility feature queries 128 via a user interface 124, such as the output presentation GUI 138 as described herein. In some examples, the facility analysis platform 122 is configured to perform algorithms and/or operations on the facility feature queries 128 and the facility data objects 134 to generate the query response data structure 136. Additionally, or alternatively, in some examples, the facility analysis platform 122 includes artificial intelligence (AI) and/or machine learning (ML) models that are trained to perform analyses on the input data to generate the output data in the query response data structure 136.

In some examples, the facility feature query 128 includes data categories 130 with which the query 128 is associated and requirements 132 that define the boundaries or limits of the query 128. For instance, in an example, a facility feature query 128 requests an ordered list of facilities 102 with average energy consumption values in a specific range. In such an example, a data category 130 of the facility feature query 128 is the average energy consumption value while a requirement 132 of the facility feature query 128 is the range in which the average energy consumption of the facilities 102 must fall to be included in the output data. Thus, in response to such a query 128, the facility analysis platform 122 generates a query response data structure 136 that includes a group of facilities 102 with average energy consumption values that fall within the specified range. The group of facilities 102 are ordered according to the average energy consumption values (e.g., high values to low values or low values to high values). Additionally, in some examples, the query response data structure 136 is generated to include other information about the facilities 102 listed therein, such as location data and/or equipment specification data. Thus, the ordered data in the query response data structure 136 can be reviewed by a user, such as the author of the original query 128, and the other information about the facilities 102 can be observed. Other examples of queries 128 being processed are described in greater detail below.

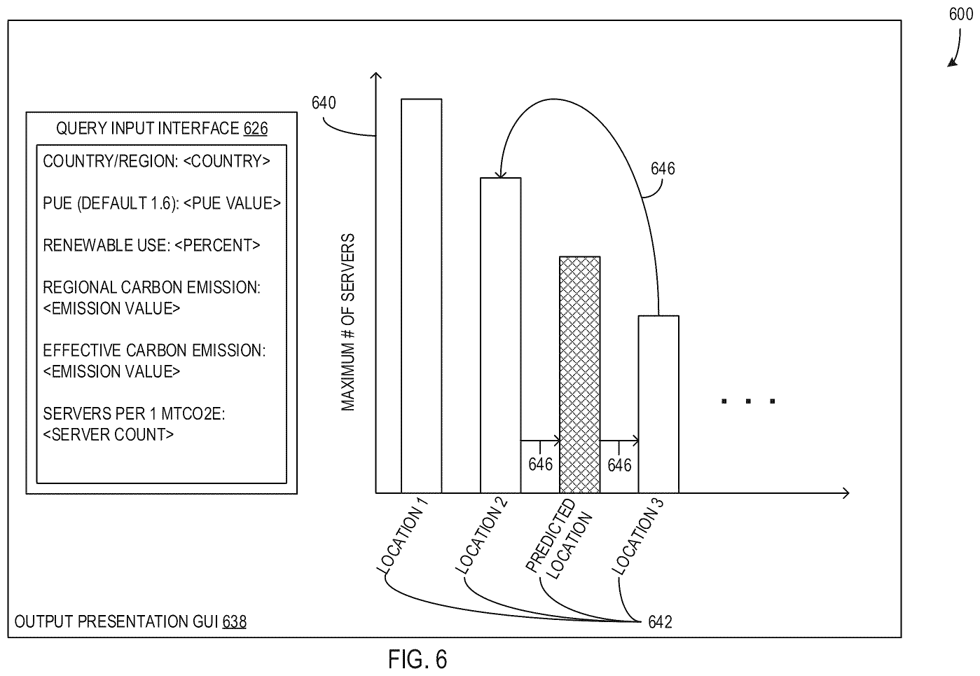

The user interface 124 is configured to interact with the facility analysis platform 122 by providing the facility feature query 128 using a query input interface 126 and by presenting the query response data structure 136 using the output presentation GUI 138. In some examples, the user interface 124 enables users to define facility feature queries 128, including the data categories 130 and requirements 132 associated therewith. For instance, in an example, the query input interface 126 displays a prompt that prompts a user to provide a data category 130 and an associated requirement 132. In some such examples, the prompt is displayed on a GUI and the user is enabled to enter information using another user interface, such as a keyboard, touchscreen, voice command, or the like. In response to a user entering information for the displayed prompt, the query input interface 126 updates the GUI and more moves elements of the GUI to display other options to the user, such as an option to define more data categories 130 or requirements 132 or an option to provide the query 128 as currently defined to the facility analysis platform 122 for analysis. Examples of the query input interface 126 are defined in greater detail below with respect to FIG. 6.

In some examples, the facility analysis platform 122 is configured to generate and/or populated facility data objects 134 with data from the facility resource usage data lake 108. In some such examples, the facility data objects 134 are written to one or more memory modules of a computing device associated with the facility analysis platform 122. The data that is used to populate the facility data objects 134 is selected from the facility resource usage data lake 108 depending on the facility feature query 128. For instance, in an example where the facility feature query 128 is associated with average electricity consumption of facilities, average electricity consumption values for the facilities 102 are obtained from the facility resource usage data lake 108 and used to populate the facility data objects 134. Additionally, in some examples, other data is used to populate the facility data objects 134, such as facility feature data 114-116 that indicates location information and/or equipment specification information about the facilities that are to be analyzed.

Further, in some examples, each facility data object 134 is associated with a specific facility 102 and the data therein is data associated with that specific facility 102. Thus, in an example where data associated with 20 facilities 102 is obtained by the facility analysis platform 122, 20 facility data objects 134 are generated and populated, with each facility data object 134 being associated with one of the 20 facilities 102.

The facility analysis platform 122 is configured to generate and populate a query response data structure 136 in response to the facility feature query 128 and using the data of the facility data objects 134 as described herein. In some examples, the query response data structure 136 includes a data entry for each facility data object 134 and/or a data entry for some group of the facility data objects 134. Further, in some such examples, the query response data structure 136 is ordered, or the data entries of the query response data structure 136 are arranged in a defined order, based on the facility feature query 128. For instance, in an example where the facility feature query 128 requests a list of facilities ordered based on amount of electricity used from renewable sources, the query response data structure 136 includes data entries associated with individual facilities and ordered from the facility that uses that largest amount of electricity from renewable sources to the facility that uses the smallest amount of electricity from renewable sources. In some such examples, those data entries the query response data structure 136 further include information about those facilities, such as the country or territory in which they are located, the quantity and type of equipment devices used, or the like. In this way, the query response data structure 136 is populated with information that can be used by a user to further evaluate the response data.

The output presentation GUI 138 is configured to interact with the facility analysis platform 122 by receiving the query response data structure 136 and displaying or otherwise presenting information from the query response data structure 136 to users of the user interface 124. In some examples, output presentation GUI 138 displays the information in the query response data structure 136 in the form of text, charts, graphs, images, and/or other types of display media. For instance, in an example, the query response data structure 136 includes a list of data values that indicate a quantity of server devices that can be used at each facility while keeping carbon emissions below a threshold. In such an example, the output presentation GUI 138 displays a bar chart with the analyzed facilities on the x-axis and the heights of the bars on the y-axis indicating the quantity of server devices that can be used at each facility. A similar example is described in more detail below with respect to FIG. 6.

Additionally, or alternatively, in some examples, the output presentation GUI 138 enables users to interact with the displayed information to change the focus of what is displayed, to access additional information that is initially hidden, to cause elements of the GUI 138 to be moved to other locations, or the like. Further, in some examples, the output presentation GUI 138 is configured to dynamically updated as new information is provided to it. For instance, in an example, the output presentation GUI 138 is displaying information about electricity consumption of a group of facilities in near real-time, with the facilities ordered in the GUI 138 based on current electricity consumption. Based on near real-time changes in the electricity consumption of those facilities, the facility analysis platform 122 updates the information provided to the output presentation GUI 138 and, in response to receiving the new information, the output presentation GUI 138 automatically moves the displayed facility data entries to other locations of the GUI 138 in order to re-order the facilities according to the new electricity consumption information.

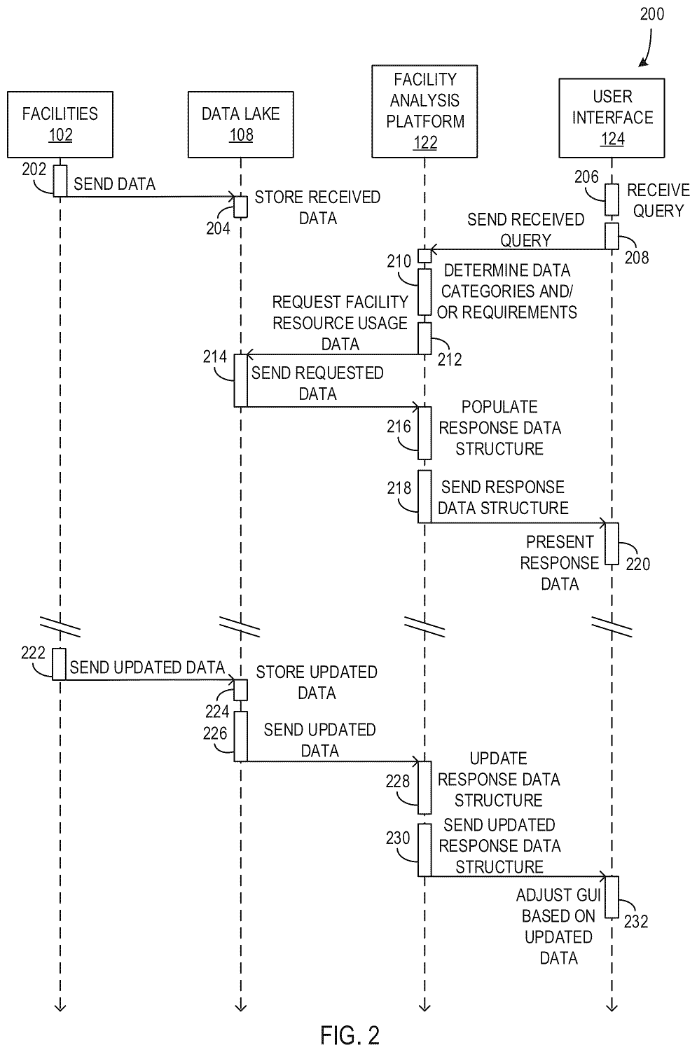

FIG. 2 is a sequence diagram illustrating a process 200 for analyzing and presenting facility data (e.g., data of a query response data structure 136) based on a received query (e.g., a facility feature query 128). In some examples, the process 200 is performed by or in association with a system such as system 100 of FIG. 1.

At 202, facilities 102 send data to the data lake 108. In some examples, the data sent by the facilities 102 includes facility feature data 104 and/or resource usage data 106. Further, in some examples, the facilities 102 are configured to send the data periodically or in response to defined events. Alternatively, or additionally, in some examples, the data lake 108 is configured to send data requests to the facilities 102 and the facilities 102 then respond to those data requests by sending the data at 202.

At 204, the data lake 108 stores the received data. In some examples, the data is stored in association with facility IDs 110-112 as described above with respect to FIG. 1.

At 206, the user interface 124 receives a query. In some examples, the user interface 124 displays or otherwise presents an interface that enables a user to define the aspects of the query, such as the data categories 130 and/or the requirements 132 of a facility feature query 128. For instance, in an example, the user interface 124 displays a query input interface 126 that prompts a user to provide definitions of the types of data to be analyzed, the way that the facility data is to be analyzed, and the requirements for the output data (e.g., data value threshold or ranges). In other examples, more, fewer, or other types of query information are received by the user interface 124 without departing from the description.

At 208, the user interface 124 sends the received query to the facility analysis platform 122 and, at 210, the facility analysis platform determines the data categories 130 and/or the requirements 132 of the query. In some examples, the facility analysis platform 122 determines the types of data to request from the data lake 108 and/or the subset of facilities 102 about which to request data from the data lake 108.

At 212, the facility analysis platform 122 requests facility resource usage data from the data lake 108. In some examples, the request includes types and/or categories of resource usage data from at least a portion of the facilities 102 as well as at least a portion of the facility feature data of those same facilities 102.

At 214, the data lake 108 sends the requested data to the facility analysis platform and at 216, the facility analysis platform 122 populates a response data structure (e.g., a query response data structure 136). In some examples, populating the response data structure includes analyzing the data received from the data lake 108 and ordering and/or otherwise arranging the data in the response data structure based on aspects of the received query (e.g., the query requests a list of facilities in an order based on a data value and the facility analysis platform populates the response data structure in such a way to arrange the data in the requested order).

At 218, the facility analysis platform 122 sends the response data structure to the user interface 124 and, at 220, the user interface 124 presents the response data from the response data structure in response to the received query. In some examples, presenting the response data includes displaying text, shapes, and/or images on a GUI, automatically moving objects to different locations on a GUI, and/or otherwise updating or adjusting a GUI to display the response data. For instance, in an example, the response data is displayed in the form of a bar chart with bars representing various data values of the response data.

Later, at 222, one or more of the facilities 102 send updated data to the data lake 108. In some examples, the updated data has changed due to changes in the facility features and/or the resource usage of one or more of the facilities 102. For instance, in an example, a facility 102 is upgraded to include more equipment, thereby changing the facility feature data and the resource usage data of the facility 102. In some such examples, the facilities 102 are configured to send updated data to the data lake 108 when changes such as those described herein occur.

At 224, the updated data is stored in the data lake 108 and, at 226, the data lake 108 sends the updated data to the facility analysis platform 122. In some examples, the data lake 108 is configured to send updated data to the facility analysis platform 122 when it receives it from the facilities 102. Further, in some such examples, the data lake 108 is configured to store previously data requests from the facility analysis platform 122 and, if data that was sent in response to those stored requests is updated, that updated data is sent to the facility analysis platform 122. Alternatively, or additionally, the facility analysis platform 122 is configured to request updated data associated with currently active queries periodically and/or based on the occurrence of defined events.

At 228, the facility analysis platform 122 updates the response data structure and, at 230, the facility analysis platform 122 sends the updated response data structure to the user interface 124. Alternatively, in some examples, the facility analysis platform 122 sends just the updated data of the response data structure to the user interface 124. Further, in some examples, the facility analysis platform 122 is configured to dynamically send updated response data to the user interface 124 when it is received, enabling the user interface 124 to be dynamically and automatically adjusted to present the updated data.

At 232, the user interface 124 adjusts the GUI based on the updated data. In some examples, the adjustment of the GUI includes automatically moving GUI elements to different locations of the GUI, creating new GUI elements, removing GUI elements, and/or otherwise changing the appearance of GUI elements. Examples of these adjustments are provided below.

In an example, a facility feature query 128 is generated that requests a quantity of server devices that can be deployed to a facility in a location based on carbon emissions associated with that location. The data categories 130 of the query 128 include an energy usage measurement of the server devices (e.g., an average kilowatt-hour value of the server devices), the power usage effectiveness (PUE) of the facilities (i.e., the ratio of total energy used by a facility to energy used by server devices performing computational operations at the facility), emission factor values of the facilities and/or associated locations (e.g., a value indicating the quantity of carbon dioxide (CO₂) equivalents (CO2e) emitted by a facility per kilowatt-hour of energy used), and a percentage of onsite renewable energy used (e.g., the percentage of energy used by a facility that is generated by solar energy, wind energy, or other forms of renewable energy). In other examples, more, fewer, or different data categories are used in the query 128 without departing from the description.

The facility analysis platform 122 obtains data of these data categories 130 from the facility resource usage data lake 108 and analyzes it to generate a query response data structure 136. In some such examples, the facility analysis platform 122 determines a quantity of server devices that can be used at each facility while maintaining a carbon emission rate that remains below a defined threshold (e.g., 1 metric ton of CO2e (MTCO2e) or less in 30 days) through analysis of the obtained data. Further, in some cases, the facility analysis platform 122 is further configured to predict or otherwise determine a likely quantity of server devices that can be used at a theoretical facility in location based on data gathered about that location and on data gathered in association with similar existing facilities. In this way, the facility analysis platform 122 provides a predictive response indicating the size of server facilities that could be deployed in various locations, enabling users to plan where to deploy new server facilities.

In some examples, the facility analysis platform 122 uses average energy consumption values for all server devices in the generation of the above-described response to the query 128. Alternatively, or additionally, the query 128 includes specification information about the server devices that will be deployed and the facility analysis platform 122 is configured to account for these details by obtaining energy consumption values and associated specification data of existing server devices, identifying server devices that are the same as or similar to the server devices that will be deployed, and using the energy consumption values of the identified server devices in the analysis when generating the query response data structure 136.

In another example, a facility feature query 128 requests information about how much overhead energy usage needs to be reduced at a facility in order to meet a defined carbon emission threshold. The facility analysis platform 122 obtains data indicating the current PUE of the facility, current energy usage data, and current carbon emission rates associated with the facility. The facility analysis platform 122 analyzes the data and generates a query response data structure 136 that is populated with data about the facility, including a data value indicating a percentage of reduction in overhead energy consumption required to meet the threshold and an associated energy consumption value (e.g., a quantity of kilowatt-hours) by which the overhead energy consumption needs to be reduced. The data of the query response data structure 136 is displayed on the output presentation GUI 138, illustrating to a user the changes that are needed. Additionally, or alternatively, the facility analysis platform 122 includes a list of sources of the overhead energy consumption in the facility with quantities of energy consumption associated with each of the sources (e.g., lighting the facility, cooling the facility, etc.). The list of sources is displayed in order of most energy consumed and/or several of the highest-consuming sources are highlighted as targets for reduction of energy consumption.

Additionally, or alternatively, in another example, a similar query 128 requests a quantity or percentage of renewable energy usage that is needed for a facility to meet a carbon emission threshold. The facility analysis platform 122 analyzes the data of the facility and determines an amount that the renewable energy usage that must be used by the facility to meet the threshold (e.g., a percentage goal, such as 25% of consumed energy is from renewable sources, and/or a quantity goal, such as 150 kWh per server device per month is from renewable sources). The data is then displayed on the output presentation GUI 138 as described herein. Further, in some examples, the facility analysis platform 122 uses data from the data lake 108 to determine locations where the desired quantity of renewable energy is available and recommends those locations for expansion of server facilities.

Further, in similar examples, the facility analysis platform 122 provides data that indicates the quantity of renewable energy that must be used and/or the degree to which overhead energy consumption must be reduced for a server facility in a first location to be able to match the performance of a server facility in a second location. This comparative data is displayed on the output presentation GUI 138 to a user as described herein, enabling the use to compare and contrast two or more facility locations and make decisions about how to improve the performance of an associated company while maintaining an acceptable level of energy usage and/or carbon emissions.

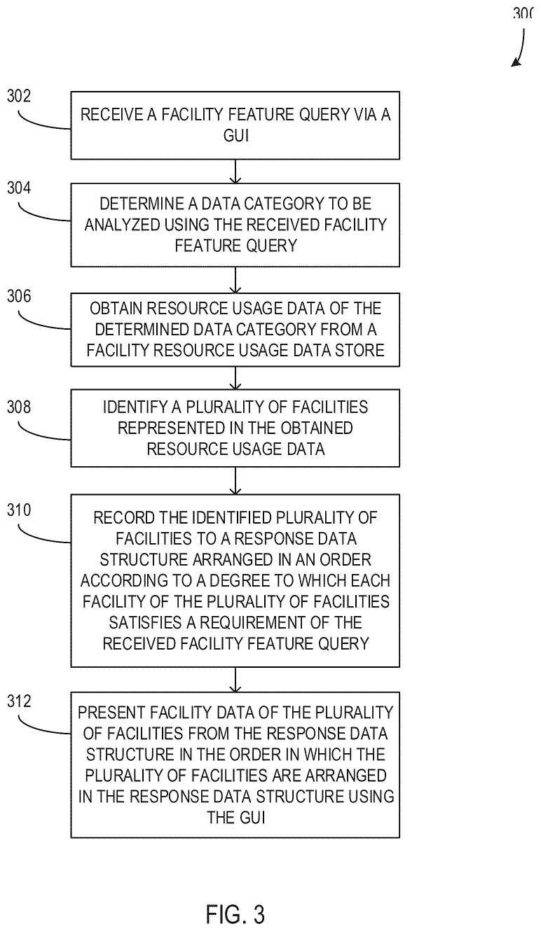

FIG. 3 is a flowchart illustrating a method 300 for analyzing and presenting facility data based on a received query (e.g., a facility feature query 128). In some examples, the method 300 is executed or otherwise performed in a system such as system 100 of FIG. 1.

At 302, a facility feature query is received via a GUI (e.g., query input interface 126). In some examples, the received facility feature query includes one or more data categories 130 and/or requirements 132 as described herein. Additionally, or alternatively, the facility feature query includes data associated with requesting analysis of facility data to provide a query response (e.g., a request to determine a quantity of server devices a facility can use while remaining under a carbon emission threshold).

Further, in some examples, the received facility feature request includes a request that carbon emissions data of a plurality of server facilities be compared to a carbon emissions threshold requirement. In some such examples, presenting the facility data further includes presenting carbon emissions data associated with the plurality of server facilities and arranging the presented carbon emissions data in an order based on a degree to which the plurality of server facilities satisfy the carbon emissions threshold requirement.

At 304, a data category to be analyzed is determined using the received facility feature query. In some examples, the data categories 130 and/or requirements 132 are analyzed to determine the data categories that need to be obtained to respond to the query. For instance, in an example, it is determined that, in order to determine the quantity of server devices a facility can use while remaining under a carbon emission threshold, the data that must be obtained includes the energy consumption of the server devices, carbon emission rates of the energy sources used by the facility, renewable energy usage available to the facility, or the like.

In some examples associated with carbon emissions data as described above, one or more data categories to be analyzed are determined at 304, including one or more of a location-based energy cost category, an equipment-based energy cost category, a power usage effectiveness (PUE) category, an onsite renewable energy usage category, a workload factors category, or a location-based emission factors category.

At 306, resource usage data of the determined data category is obtained from a facility resource usage data store (e.g., the facility resource usage data lake 108). In some examples, the resource usage data is obtained by the facility analysis platform 122 via an interface with the facility resource usage data store as described herein.

At 308, a plurality of facilities represented in the obtained resource usage data are identified.

At 310, the identified plurality of facilities are recorded to a response data structure arranged in an order according to a degree to which each facility of the plurality of facilities satisfies a requirement of the received facility feature query.

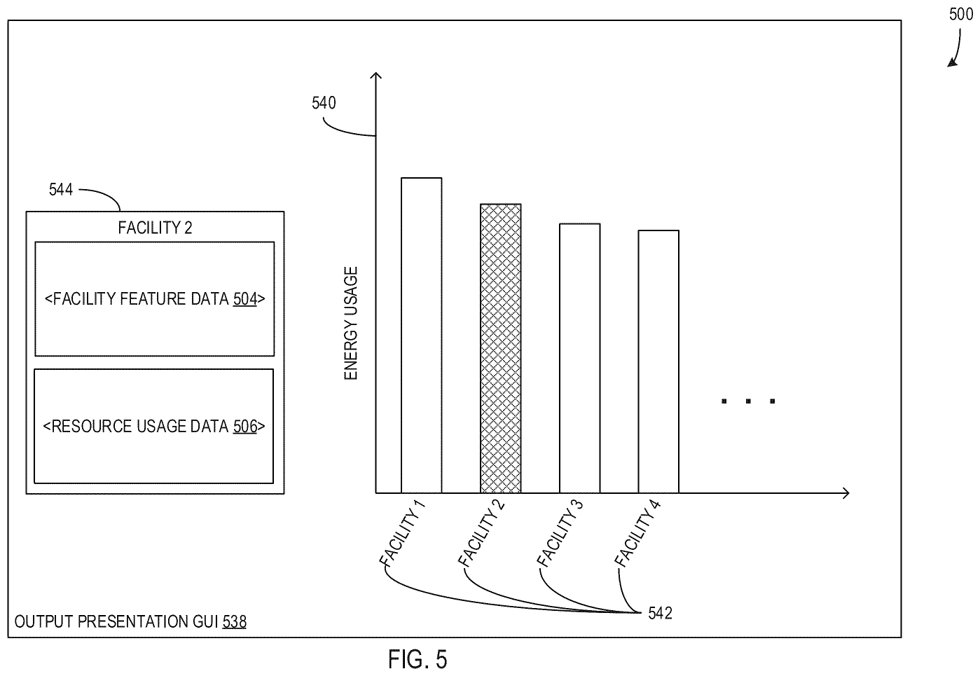

At 312, facility data of the plurality of facilities from the response data structure is presented in the order in which the plurality of facilities are arranged in the response data structure using the GUI. In some examples, presenting facility data includes displaying a graphic that visually indicates the degree to which each facility of the plurality of facilities satisfies the requirement of the facility feature query. For instance, in an example associated with carbon emissions as described above, presenting the facility data includes displaying a graphic that indicates the degree to which each server facility satisfies the carbon emissions threshold requirement. Examples of such graphics are described in greater detail below with respect at least to FIGS. 5 and 6.

Additionally, or alternatively, in some examples, the method 300 includes controlling a device or devices based on the analysis of the facility data. In such an example, a facility that fails to satisfy a requirement of a facility feature query is identified (e.g., the requirement requires the identified facility to use less energy over a period of time than an energy usage threshold). Based on identifying the facility, the entity performing the method 300 (e.g., the facility analysis platform 122 or a related entity) automatically reduces an operational period of a device of the identified facility. The automatic reduction of the operational period reduces the amount of time the device operates over a period of time, thereby reducing its consumption of energy over that same period. The degree to which the operational period is reduced is based on the degree to which the identified facility fails to satisfy the requirement, such that the reduction in energy used by the device is sufficient to enable the identified facility to meet the requirement. In other examples, more or different devices are controlled in response to the facility data analysis and/or those devices are controlled in different ways to enable associated facilities to meet requirements of facility feature queries without departing from the description (e.g., a percentage of total devices of a facility are deactivated, devices are switched to modes that consume less energy, or the like).

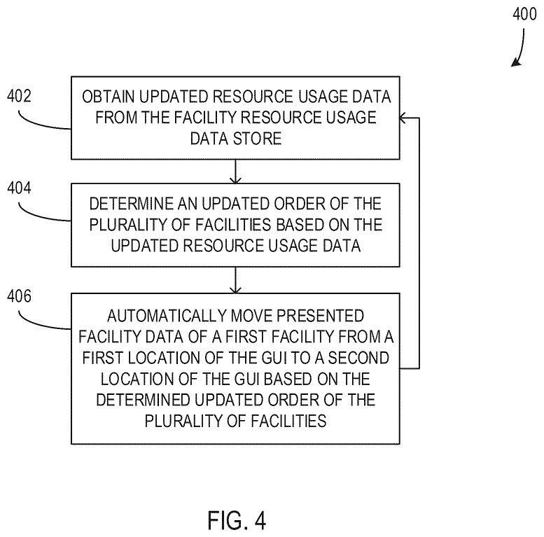

FIG. 4 is a flowchart illustrating a method 400 for updating presented facility data based on received updated resource usage data. In some examples, the method 400 is performed after the method 300 of FIG. 3. Additionally, or alternatively, in some examples, the method 400 is executed or otherwise performed in a system such as system 100 of FIG. 1.

At 402, updated resource usage data is obtained from the facility resource usage data store (e.g., the facility resource usage data lake 108). In some examples, the data store is configured to send the updated resource usage data to the facility analysis platform 122. Alternatively, or additionally, in some examples, the facility analysis platform 122 requests updated resource usage data from the data store based on a facility feature query 128 being received recently and that query 128 remaining active (e.g., the output presentation GUI 138 is still presenting data associated with the query 128 to a user).

At 404, an updated order of the plurality of facilities is determined based on the updated resource usage data. For instance, in an example, the plurality of facilities are ordered based on the rate of resource usage by each facility (e.g., the facility that uses the most resources is first, the facility that uses the second most resources is second, etc.). In some such examples, the updated resource usage data indicates that a second-listed facility now uses more resources than the first-listed facility, such that they are reordered to reflect the change in relative resource usage.

At 406, the presented facility data of a first facility is automatically moved from a first location of the GUI to a second location of the GUI based on the determined updated order of the plurality of facilities. For instance, in the example described above, a first facility and associated facility data are listed first on the GUI and a second facility and associated facility data are listed second on the GUI. Based on the determined updated order of the plurality of facilities, the second facility and associated facility data are moved up to be listed first on the GUI while the first facility and associated facility data are moved down to be listed second, reflecting the change in the determined updated order of the plurality of facilities. It should be understood that, in other examples, more and/or different movements of facility data are performed as a result of updated resource usage data without departing from the description.

Further, in some examples, in addition to updating the GUI based on the updated facility data, a source of the received facility feature query is identified and a notification is caused to be displayed at a notification location on a GUI associated with the identified source based on the updated facility data (e.g., resource usage data). For instance, in an example, a user creates the facility feature query and, upon being presented the associated facility data on the GUI, the user selects to keep the GUI element in which the facility data is being displayed up to date over time. As a result, the facility analysis platform 122 periodically obtains updated facility data associated with the facility feature query over time and, upon receiving that updated facility data, method 400 is performed as described. When the updated facility data is received, a notification icon or other GUI component is displayed to the user on the GUI, notifying the user of the changing facility data.

FIG. 5 is a diagram illustrating a graphical user interface (GUI) 500 for presenting facility data (e.g., facility feature data 114-116 and/or resource usage data 118-120) from a plurality of facilities (e.g., facilities 102). In some examples, the GUI 500 is executed as part of a method such as methods 300 and/or 400 of FIGS. 3 and/or 4, respectively. Further, in some examples, the GUI 500 is executed in association with a system such as system 100 of FIG. 1.

The GUI 500 includes an output presentation GUI 538. The output presentation GUI 538 displays a bar graph 540 that graphs a plurality of facilities 542 on the x-axis against energy usage of those facilities on the y-axis. The facilities 542 are displayed in an order from the highest energy usage on the left to the lowest energy usage on the right. Additionally, Facility 2 of the facilities 542 is selected or otherwise highlighted on the graph 540. In some examples, a user of the GUI 500 has selected Facility 2 on the graph 540 to view more information about facility 2. The output presentation GUI 538 includes a facility data portion 544 that displays data associated with facility 2. The displayed facility data includes at least a portion of the facility feature data 504 and at least a portion of the resource usage data 506. The displayed data includes data directly from the facility resource usage data lake 108 and/or data that has been processed and/or generated during the analysis performed by the facility analysis platform 122.

It should be understood that, in some examples, the facility data portion 544 of the output presentation GUI 538 dynamically changes based on which facility is highlighted in the bar graph 540. For instance, if the user of the GUI 500 selects Facility 3 from the facilities 542, the facility data portion 544 automatically changes to display the name of Facility 3 and associated facility feature data 504 and resource usage data 506. Additionally, or alternatively, in other examples, more, fewer, or different types of data re displayed in the output presentation GUI 538 without departing from the description (e.g., a different type of graph 540 is displayed based on what is requested by the facility feature query).

FIG. 6 is a diagram illustrating a GUI 600 for presenting and updating facility data (e.g., facility feature data 114-116 and/or resource usage data 118-120) of a plurality of facilities (e.g., facilities 102). In some examples, the GUI 600 is executed as part of a method such as methods 300 and/or 400 of FIGS. 3 and/or 4, respectively. Further, in some examples, the GUI 500 is executed in association with a system such as system 100 of FIG. 1.

The GUI 600 includes an output presentation GUI 638. The output presentation GUI 638 displays a bar graph 640 that graphs a plurality of facility locations 642 on the x-axis against a quantity or number of servers that can be deployed to the locations while maintaining carbon emissions below a threshold (e.g., 1 MTCO2e or less over 30 days). The bar graph 640 illustrates a maximum number of servers for locations 1, 2, and 3. Further, the bar graph 640 includes a maximum number of servers for a predicted location based on the data that is provided in the query input interface 626. The bars of the bar graph 640 are displayed in order from the highest maximum number of servers to the lowest maximum number of servers and the predicted location can be compared to locations 1, 2, and 3 based at least in part on this order of bars.

The query input interface 626 enables a user to input data values of a predicted location to compare the predicted location with existing facility locations. As illustrated, the query input interface 626 enables a user to provide a country or region, a PUE value, a percentage of renewable energy use with respect to total energy use, a regional carbon emission value, an effective carbon emission value, and a server count representing a number of servers per 1 MTCO2e. In other examples, users are enabled to provide more, fewer, and/or different data values via the query input interface 626 for analysis and display in the output presentation GUI 638 without departing from the description.

In some examples, after the output presentation GUI 638 is initially displayed with the locations 1, 2, and 3 and the predicted location displayed in the order as illustrated, updated information is obtained and provided to the output presentation GUI 638 (e.g., by a facility analysis platform 122 as described herein). The updated information about location 3 indicates that it now has a maximum number of servers that exceeds that of location 2 but is still less than that of location 1 (e.g., the use of renewables in location 3 has increased, thereby improving the maximum number of servers for location 3). As a result of this change, at 646, the bar and label of location 3 is moved in the GUI 638 to assume the current location of the bar of location 2, while the bars of location 2 and the predicted location are moved to the right to maintain the order of the bars based on the maximum numbers of servers. In some such examples, the change to the GUI 638 includes the bars and labels of the locations sliding or otherwise moving across the GUI 638 to take their new places in the bar graph 640. Alternatively, in other examples, the GUI 638 is entirely redrawn to account for the changes and maintain the order of the bars in the bar graph 640 as described herein.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device. In some examples, analyzing and presenting data associated with facility resource use in response to facility feature queries as described herein is accomplished by software, hardware, and/or firmware.

In some examples, computer executable instructions are provided using any computer-readable media that is accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receives output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: receive a facility feature query via a graphical user interface (GUI); determine a data category to be analyzed using the received facility feature query; obtain resource usage data of the determined data category from a facility resource usage data store using a query interface of the facility resource usage data store; identify a plurality of facilities represented in the obtained resource usage data; record the identified plurality of facilities to the memory in a response data structure, wherein the recorded plurality of facilities in the response data structure are arranged in an order according to a degree to which each facility of the plurality of facilities satisfies a requirement of the received facility feature query; and present facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

An example computerized method comprises receiving a facility feature query via a graphical user interface (GUI); determining a data category to be analyzed using the received facility feature query; obtaining resource usage data of the determined data category from a facility resource usage data store using a query interface of the facility resource usage data store; identifying a plurality of facilities represented in the obtained resource usage data; recording the identified plurality of facilities to a memory in a response data structure, wherein the recorded plurality of facilities in the response data structure are arranged in an order according to a degree to which each facility of the plurality of facilities satisfies a requirement of the received facility feature query; and presenting facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

One or more computer storage media having computer-executable instructions that, upon execution by a processor, cause the processor to at least: receive a facility feature query via a graphical user interface (GUI); determine a data category to be analyzed using the received facility feature query; obtain resource usage data of the determined data category from a facility resource usage data store using a query interface of the facility resource usage data store; identify a plurality of facilities represented in the obtained resource usage data; record the identified plurality of facilities to a memory in a response data structure, wherein the recorded plurality of facilities in the response data structure are arranged in an order according to a degree to which each facility of the plurality of facilities satisfies a requirement of the received facility feature query; and present facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

Alternatively, or in addition to the other examples described herein, examples include any combination of the following:
further comprising: identifying a facility of the plurality of facilities that fails to satisfy the requirement of the received facility feature query, wherein the requirement requires the identified facility to use less energy over a time period than an energy usage threshold; and automatically reducing an operational period of a device of the identified facility based on the degree to which the identified facility fails to satisfy the requirement, whereby energy usage over time of the identified facility is reduced.
wherein the received facility feature query includes a request that carbon emissions data of a plurality of server facilities be compared to a carbon emissions threshold requirement; and wherein presenting the facility data of the plurality of facilities includes presenting carbon emissions data associated with the plurality of server facilities and arranging the presented carbon emissions data in an order based on a degree to which the plurality of server facilities satisfy the carbon emissions threshold requirement.
wherein determining the data category to be analyzed further includes determining one or more of the following data categories to be analyzed: a location-based energy cost category; an equipment-based energy cost category; a power usage effectiveness (PUE) category; an onsite renewable energy usage category; a workload factors category; or a location-based emission factors category.
The computerized method of claim 10, wherein presenting facility data further includes displaying a graphic that visually indicates a degree to which each server facility of the plurality of server facilities satisfies the carbon emissions threshold requirement.
further comprising: obtaining updated resource usage data from the facility resource usage data store; determining an updated order of the plurality of server facilities based on the updated resource usage data; and automatically moving presented carbon emissions data of a first server facility from a first location of the GUI to a second location of the GUI based on the determined updated order of the plurality of server facilities.
further comprising: identifying a source of the received facility feature query; and causing a notification to be displayed at a notification location on a GUI associated with the identified source based on the updated resource usage data, whereby the identified source is notified that the presented facility data in response to the facility feature query has changed.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving a facility feature query via a graphical user interface (GUI); exemplary means for determining a data category to be analyzed using the received facility feature query; exemplary means for obtaining resource usage data of the determined data category from a facility resource usage data store using a query interface of the facility resource usage data store; exemplary means for identifying a plurality of facilities represented in the obtained resource usage data; exemplary means for recording the identified plurality of facilities to a memory in a response data structure, wherein the recorded plurality of facilities in the response data structure are arranged in an order according to a degree to which each facility of the plurality of facilities satisfies a requirement of the received facility feature query; and exemplary means for presenting facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
receive a facility feature query via a graphical user interface (GUI);
determine a data category to be analyzed using the received facility feature query;
obtain resource usage data of the determined data category from a facility resource usage data store using a query interface of the facility resource usage data store;
identify a plurality of facilities represented in the obtained resource usage data;
record the identified plurality of facilities to the memory in a response data structure, wherein the recorded plurality of facilities in the response data structure are arranged in an order according to a degree to which each facility of the plurality of facilities satisfies a requirement of the received facility feature query; and
present facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

2. The system of claim 1, wherein the memory and the computer program code are further configured to cause the processor to:
identify a facility of the plurality of facilities that fails to satisfy the requirement of the received facility feature query, wherein the requirement requires the identified facility to use less energy over a time period than an energy usage threshold; and
automatically reduce an operational period of a device of the identified facility based on the degree to which the identified facility fails to satisfy the requirement, whereby energy usage over time of the identified facility is reduced.

3. The system of claim 1, wherein the received facility feature query includes a request that carbon emissions data of a plurality of server facilities be compared to a carbon emissions threshold requirement; and
wherein presenting the facility data of the plurality of facilities includes presenting carbon emissions data associated with the plurality of server facilities and arranging the presented carbon emissions data in an order based on a degree to which the plurality of server facilities satisfy the carbon emissions threshold requirement.

4. The system of claim 3, wherein determining the data category to be analyzed further includes determining one or more of the following data categories to be analyzed: a location-based energy cost category; an equipment-based energy cost category; a power usage effectiveness (PUE) category; an onsite renewable energy usage category; a workload factors category; or a location-based emission factors category.

5. The system of claim 3, wherein presenting facility data further includes displaying a graphic that visually indicates a degree to which each server facility of the plurality of server facilities satisfies the carbon emissions threshold requirement.

6. The system of claim 3, wherein the memory and the computer program code are further configured to cause the processor to:
obtain updated resource usage data from the facility resource usage data store;
determine an updated order of the plurality of server facilities based on the updated resource usage data; and
automatically move presented carbon emissions data of a first server facility from a first location of the GUI to a second location of the GUI based on the determined updated order of the plurality of server facilities.

7. The system of claim 6, wherein the memory and the computer program code are further configured to cause the processor to:
identify a source of the received facility feature query; and
cause a notification to be displayed at a notification location on a GUI associated with the identified source based on the updated resource usage data, whereby the identified source is notified that the presented facility data in response to the facility feature query has changed.

8. A computerized method comprising:
receiving a facility feature query via a graphical user interface (GUI);
determining a data category to be analyzed using the received facility feature query;
obtaining resource usage data of the determined data category from a facility resource usage data store using a query interface of the facility resource usage data store;
identifying a plurality of facilities represented in the obtained resource usage data;
recording the identified plurality of facilities to a memory in a response data structure, wherein the recorded plurality of facilities in the response data structure are arranged in an order according to a degree to which each facility of the plurality of facilities satisfies a requirement of the received facility feature query; and
presenting facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

9. The computerized method of claim 8, further comprising:
identifying a facility of the plurality of facilities that fails to satisfy the requirement of the received facility feature query, wherein the requirement requires the identified facility to use less energy over a time period than an energy usage threshold; and
automatically reducing an operational period of a device of the identified facility based on the degree to which the identified facility fails to satisfy the requirement, whereby energy usage over time of the identified facility is reduced.

10. The computerized method of claim 8, wherein the received facility feature query includes a request that carbon emissions data of a plurality of server facilities be compared to a carbon emissions threshold requirement; and
wherein presenting the facility data of the plurality of facilities includes presenting carbon emissions data associated with the plurality of server facilities and arranging the presented carbon emissions data in an order based on a degree to which the plurality of server facilities satisfy the carbon emissions threshold requirement.

11. The computerized method of claim 10, wherein determining the data category to be analyzed further includes determining one or more of the following data categories to be analyzed: a location-based energy cost category; an equipment-based energy cost category; a power usage effectiveness (PUE) category; an onsite renewable energy usage category; a workload factors category; or a location-based emission factors category.

12. The computerized method of claim 10, wherein presenting facility data further includes displaying a graphic that visually indicates a degree to which each server facility of the plurality of server facilities satisfies the carbon emissions threshold requirement.

13. The computerized method of claim 10, further comprising:
obtaining updated resource usage data from the facility resource usage data store;
determining an updated order of the plurality of server facilities based on the updated resource usage data; and
automatically moving presented carbon emissions data of a first server facility from a first location of the GUI to a second location of the GUI based on the determined updated order of the plurality of server facilities.

14. The computerized method of claim 13, further comprising:
identifying a source of the received facility feature query; and
causing a notification to be displayed at a notification location on a GUI associated with the identified source based on the updated resource usage data, whereby the identified source is notified that the presented facility data in response to the facility feature query has changed.

15. A computer storage medium has computer-executable instructions that, upon execution by a processor, cause the processor to at least:
receive a facility feature query via a graphical user interface (GUI);
determine a data category to be analyzed using the received facility feature query;
obtain resource usage data of the determined data category from a facility resource usage data store using a query interface of the facility resource usage data store;
identify a plurality of facilities represented in the obtained resource usage data;
record the identified plurality of facilities to a memory in a response data structure, wherein the recorded plurality of facilities in the response data structure are arranged in an order according to a degree to which each facility of the plurality of facilities satisfies a requirement of the received facility feature query; and
present facility data of the plurality of facilities from the response data structure in the memory in the order in which the plurality of facilities are arranged in the response data structure using the GUI, whereby facility data of a facility that best satisfies the requirement of the received facility feature query is prioritized in the GUI.

16. The computer storage medium of claim 15, wherein the computer-executable instructions, upon execution by the processer, further cause the processor to at least:
identify a facility of the plurality of facilities that fails to satisfy the requirement of the received facility feature query, wherein the requirement requires the identified facility to use less energy over a time period than an energy usage threshold; and
automatically reduce an operational period of a device of the identified facility based on the degree to which the identified facility fails to satisfy the requirement, whereby energy usage over time of the identified facility is reduced.

17. The computer storage medium of claim 15, wherein the received facility feature query includes a request that carbon emissions data of a plurality of server facilities be compared to a carbon emissions threshold requirement; and
wherein presenting the facility data of the plurality of facilities includes presenting carbon emissions data associated with the plurality of server facilities and arranging the presented carbon emissions data in an order based on a degree to which the plurality of server facilities satisfy the carbon emissions threshold requirement.

18. The computer storage medium of claim 17, wherein determining the data category to be analyzed further includes determining one or more of the following data categories to be analyzed: a location-based energy cost category; an equipment-based energy cost category; a power usage effectiveness (PUE) category; an onsite renewable energy usage category; a workload factors category; or a location-based emission factors category.

19. The computer storage medium of claim 17, wherein presenting facility data further includes displaying a graphic that visually indicates a degree to which each server facility of the plurality of server facilities satisfies the carbon emissions threshold requirement.

20. The computer storage medium of claim 17, wherein the computer-executable instructions, upon execution by the processer, further cause the processor to at least:
obtain updated resource usage data from the facility resource usage data store;
determine an updated order of the plurality of server facilities based on the updated resource usage data; and
automatically move presented carbon emissions data of a first server facility from a first location of the GUI to a second location of the GUI based on the determined updated order of the plurality of server facilities.
